(19) United States
(12) Patent Application Publication
(10) Pub. No.: US 2023/0358529 A1
(43) Pub. Date: Nov. 9, 2023

(54) OPTICAL PRESSURE SENSOR AND APPLICATION THEREOF

(71) Applicant: Luxsentek Microelectronics Corp., New Taipei City (TW)

(72) Inventors: WEI-TING LIN, New Taipei City (TW); SHENG-CHENG LEE, New Taipei City (TW); CHAO-YANG HSIAO, New Taipei City (TW)

(21) Appl. No.: 17/840,109

(22) Filed: Jun. 14, 2022

(30) Foreign Application Priority Data
May 3, 2022 (TW) 111116697

(51) Int. Cl. G01B 11/16; H04R 1/10; G01L 1/24

(52) U.S. Cl. CPC G01B 11/16; G01L 1/24; H04R 1/1016

(57) ABSTRACT

The invention provides an optical pressure sensor. The light-emitting module emits a detection light, and the light-receiving module receives a reflected light reflected by an object. When the distance between the object and the light-receiving module changes due to external pressure, the intensity of reflected light changes. The control module compares the intensity difference of the signal to determines the pressing state.

### BACKGROUND OF THE INVENTION

### 1. Field of the Invention

The present invention relates to a pressure sensing device and in particular, to an optical pressure sensing device.

### 2. Description of the Prior Art

In the development of true wireless stereo (TWS) earphones, the in-ear type is used to reduce the noise. Striking, tapping, touching, and the fusion of the pressing and touching have been used to the manipulation of the earphone. When tapping the earphone, a pressure is induced inside the ear canal that causes discomfort. Now, the type of fusion of pressing and striking solves this problem well, has a high sensitivity and accuracy and further can avoid the false touching.

The pressure sensor can detect the variation of pressure when pressing the sensor, and catalogized by piezoelectric, piezoresistive, capacitive or micro-motor structure mode. The sensor can convert the pressure into an electrical signal by using a signal processing IC, that makes the structure complicated and the high cost. Further the internal space of the TWS earphone is limited, so the ultra-small pressure sensor is needed. The present invention proposes an optical pressure sensor and that makes novelty for TWS earphone.

### SUMMARY OF THE INVENTION

In order to solve the above problems, the present invention provides an optical pressure sensor, comprising:
a control module;
a light-emitting module, connected to the control module, configured to emit a detection light, which is a series of pulses with an interval; and
a light receiving module, connected to the control module, configured to convert a reflected light of the detection light, which is reflected by an object, into a sensed signal;
wherein when the object is pressed to change a distance to the light receiving module or the light emitting module, an intensity variation caused by the sensed signal and the control module determines a pressing state according to the intensity variation.

The optical pressure sensor of the present invention generates the pressing state by sensing the intensity variation of the reflected light from the pressable object, and the application, i.e. the terminal product, uses the pressing state to determine the manipulation. The present invention has the advantages of small size, simple structure and high sensitivity.

### BRIEF DESCRIPTION OF THE DRAWINGS

FIG. 1 is a schematic block diagram of an optical pressure sensor of the present invention.

FIG. 2A and FIG. 2B are schematic cross-sectional views before and after the pressing of the optical pressure sensor of the present invention applied to the ear handle of the earphone.

FIG. 3A and FIG. 3B are schematic cross-sectional views before and after pressing of optical pressure sensor of the present invention applied to the ear handle of an earphone of another embodiment.

FIG. 4 is a flow chart of the optical pressure sensing of the present invention.

FIGS. 5A to 5D are timing charts of sensing signals in different pressing states, which are respectively short pressing, long pressing, two consecutive pressings and three consecutive pressings.

### DESCRIPTION OF THE PREFERRED EMBODIMENTS

Below embodiments accompanied with drawings are used to explain the spirit of this invention to have better understanding for the person in this art, not used to limit the scope of this invention, which is defined by the claims. The applicant emphasizes the element quantity and size are schematic only. Moreover, some parts might be omitted to skeletally represent this invention for conciseness.

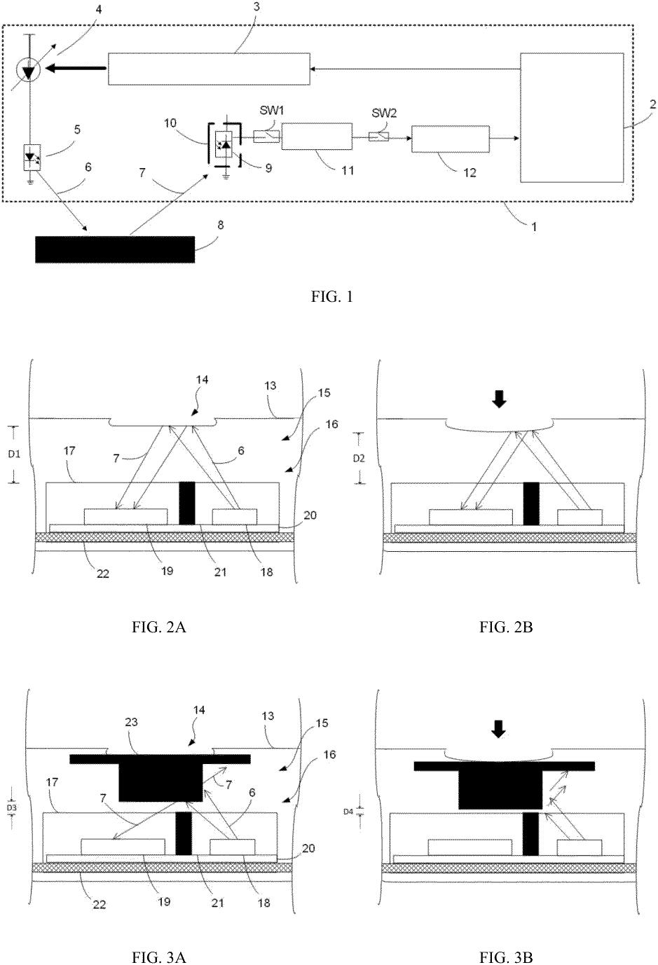

FIG. 1 is a schematic block diagram of an optical pressure sensor of the present invention. The optical pressure sensor 1 comprises a control module, a light-emitting module 18, a light-receiving module 19 and a pressable object 8. The pressable object 8 is getting closer to the light-emitting module 18 or light-receiving module 19 when being pressed and is back to the original position when the pressure is released. The pressed depth is proportional to the pressure and to the distance, so the distance can be used to detect the pressing state. The control module comprises an analog front-end module (AFE) 11, an analog-to-digital converter (ADC) 12, and a digital signal processor (DSP) 2 and timing controller 3. The light-emitting module 18 comprises a driver 4 and a light-emitting element 5. The light-receiving module 19 comprises a light-receiving element 9 and a filter 10. The pressable object 8 is used to sense the pressure variation, and the sensitivity is programmable.

The analog front-end module 11 is connected to the light-receiving element 9 through the first switching unit SW1, the analog-to-digital converter 12 is connected to the analog front-end module 11 through the second switching unit SW2, and the digital signal processor 2 is coupled between the analog-to-digital converter 12 and the timing controller 3, and the driver 4 is coupled between the timing controller 3 and the light-emitting element 5.

The light-emitting element 5 may be a miniature light-emitting element such as a light-emitting diode (LED), an organic light-emitting diode (OLED), or an infrared light (IR). The light-receiving element 9 is a photodetecting diode (PD), and a filter 10 can be optionally arranged around the light-receiving element 9 to receive light of different colors and filter out crosstalk or interference of light of different colors.

A detection light 6 is emitted by the light-emitting element 5, reflected by the object 8 to form a reflected light 7, and then received by the light-receiving element 9. When the object 8 is pressed to change the distance between the object 8 and the light-emitting element 5 or the light-receiving element 9, the intensity of the reflected light 7 varies accordingly, that means the intensity of the reflected light 7 can be used to express the pressed state of the object 8. The following shows an application of the optical pressure sensor by using a true wireless Bluetooth earphone.

FIG. 2A shows an application, where an optical pressure sensor of the present invention is disposed at the ear handle of an earphone. An inner space 15 is defined by a housing 13 with a pressing portion 14 in the ear handle, and the package structure 16 of an optical pressure sensor 1 is disposed on a circuit board 22 in the inner space 15, opposite to the pressing portion 14. The circuit board 22 is a PCB or an FPC. The package structure 16 comprises a package substrate 20, a transparent housing 17, a light emitting module 18, a light receiving module 19 and a light-shielding element 21. The light-shielding element 21 is disposed between the light-emitting module 18 and the light-receiving module 19. The transparent housing 17 covers the packaging substrate 20, the light-shielding element 21, the light-emitting module 18 and the light-receiving module 19. The pressing portion 14 is used to sense the pressure variation.

The distance D1 between the pressing portion 14 and the package structure 16 is not greater than 1 mm without pressure. A detection light 6 from the light-emitting module 18, reflected by the pressing portion 14, i.e. the reflected light 7, and received by the light-receiving module 19, as shown in FIG. 2A. When pressing the pressing portion 14, the distance D1 is reduced to D2, for example 0.8 mm, as shown in FIG. 2B. In this embodiment, the sensed light intensity increases when the pressing portion 14 is pressed.

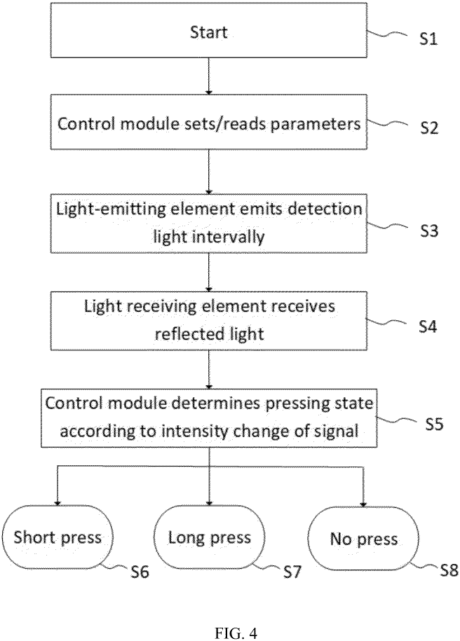

In another embodiment, as shown as FIG. 3A, a light reflecting member 23 is disposed under the pressing portion 14. The distance D3 between the light reflecting member 23 and the packaging structure 16 is not greater than 0.3 mm. The detection light 6 emitted by the light emitting module 18, and a bottom portion of the reflected light 7 from the light reflecting member 23 is received by the light receiving module 19 and another portion is scattered, as shown in FIG. 3A. When the pressing portion 14 is pressed, the distance D3 is reduced to D4, for example 0.1 mm, as shown in FIG. 3B. Most of the detection light 6 cannot reached the light receiving module 19, so the sensed light intensity decreases when the pressing portion is pressed in this embodiment.

In the embodiment shown as the FIG. 2, the inner side of the pressing portion 14 can be coated with a light-colored highly reflective material to reduce the noise caused by the crosstalk light from the transparent housing 17 or an external ambient light. In contrary, the light-reflecting member 23 can be made by a dark-colored light-absorbing material, such as dark rubber or a dark shell.

FIG. 4 is the signal process of the optical pressure sensor, comprising:

Steps S1~S3 is to initialize the device. For example, when the earphone is taken out of the charging box or connected with an external electronic device via Bluetooth, the digital signal processor sets/reads the luminous parameters (such as luminous intensity and interval) and a high/low threshold for the sensing signal and controls the timing controller to emits the detection light through driving the driver. The detection light is a series of light pulses with a fixed period of 20~200 ms.

Step S4 is to convert the reflected light into a digital signal. The reflected light is reflected by the object (such as the pressing portion 14 of the ear handle or the light-reflecting member 23) and received by the light-receiving element, the analog front-end module transformed the signal to an analog signal and the analog-to-digital converter (ADC) converts the analog signal to the digital signal. The initialized signal (without pressure) is called a contrast signal and the signal under pressure in is called a sensed signal. The contract signal and the sensed signal are transmitted to a digital signal processor.

The digital signal processor calculates the average or the median of the contrast digital signal, and a built-in memory is employed to store the contrast digital signal, the average or the median of the contrast digital signal.

Ambient light of the environment affects the detection, so the digital signal processor needs to cancel out the ambient light with the interval, such as every ten minutes or every hour.

Steps S5~S8 is to calculate the pressing state. A finite state machine (FSM) is used in the embodiment.

A ratio of the sensing digital signal value to the contrast digital signal value reaches or is larger/less than a high/low threshold, and a pressed state is defined. The threshold is 10% in one embodiment and preferably 20% in another embodiment. The ratio is less/larger than the high/low threshold mean no pressing. In addition, a short-pressed state and a long-pressed state can be defined further.

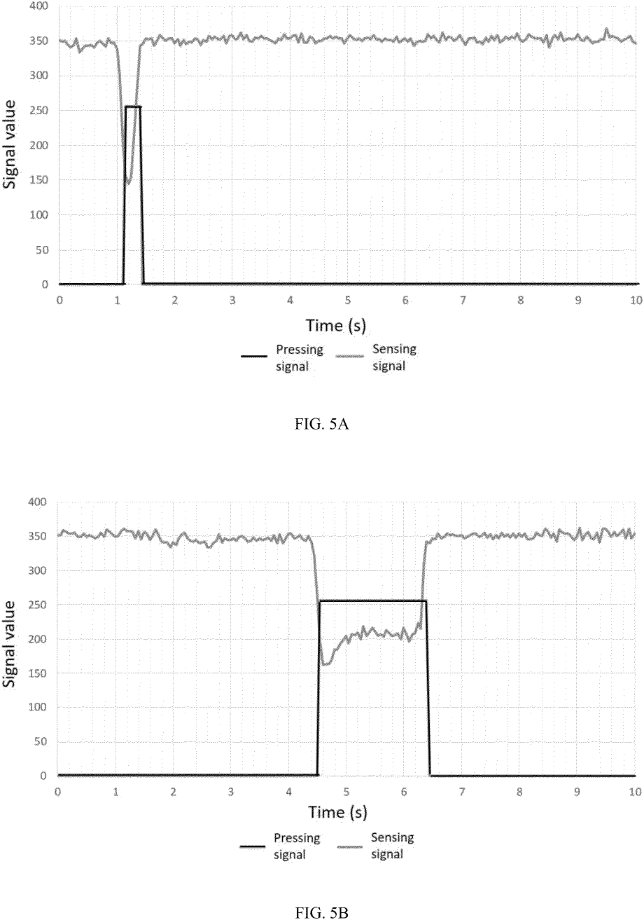

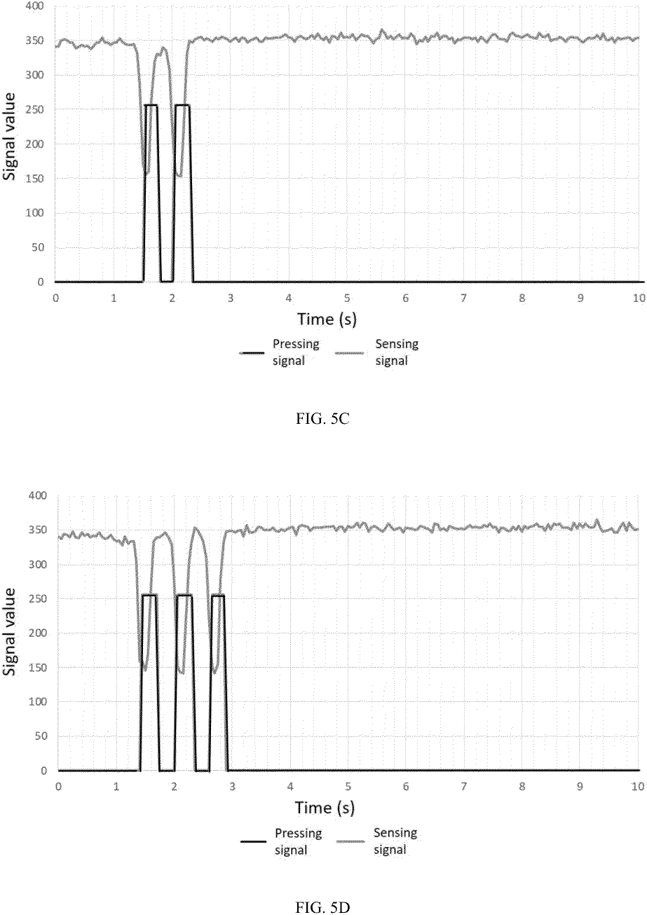

The pressed time is less than a period, for example less than 0.5 or 1 second, is a short-pressed state, as shown as FIG. 5A; and is a long-pressed state if the pressed time is greater than the period, as shown as FIG. 5B. In general, the pressed time is corresponding to the number of pulses of the detection light.

Moreover, a continuous press can be defined in some embodiments. The interval, between two continuous short-pressed states, is less than a specific value, for example 0.5 or 1 second, to define the continuous press state. A double click and triple click are defined, as shown as the FIG. 5C and FIG. 5D.

The external electronic device catches the pressed state via Bluetooth or other connection protocol to design the manipulation.

What is claimed is:

1. An optical pressure sensor, comprising:
a control module;
a light-emitting module, connected to the control module, configured to emit a detection light, which is a series of pulses with an interval; and
a light receiving module, connected to the control module, configured to convert a reflected light of the detection light, which is reflected by an object, into a sensed signal;
wherein a distance between the object and the light receiving module or the light emitting module varies when the object is pressed, an intensity variation is caused by the sensed signal, and the control module calculates a pressing state according to the intensity variation.

2. The optical pressure sensor according to claim 1, wherein the pressing state is pressed when a variation of an intensity ratio of a contrast signal to a sensed signal is larger than a threshold, wherein the contrast signal is sensed without pressure on the object and the sensed signal is sensed with a pressure on the object.

3. The optical pressure sensor according to claim 2, wherein the pressing state is catalogized into
a short press when the pressed time is less than a specific value; and
a long press when the pressed time is longer than the specific value.

4. The optical pressure sensor according to claim 2, wherein the intensity of the contrast signal is an average intensity or a median intensity of the contrast signal.

5. The optical pressure sensor according to claim 1, wherein the interval is 20~200ms.

6. The optical pressure sensor according to claim 1, wherein the control module comprises:
an analog front-end module configured to convert the sensed signal into a sensed analog signal;
an analog-to-digital converter configured to convert the sensed analog signal into a sensed digital signal;
a digital signal processor configured to calculate the pressing state according to the intensity variation of the sensed digital signal; and
a timing controller, connected between the digital signal processor and the light-emitting module, configured to determine the detection light.

7. The optical pressure sensor according to claim 6, wherein a finite state machine is employed by the digital signal processor to determine the pressing state.

8. An ear handle of an earphone comprising a housing configured to define an inner space, wherein the housing comprises a pressing portion and an optical pressure sensor of claim 1 disposed in the inner space, opposite to the pressing portion.

9. The ear handle according to claim 8, further comprising a light reflecting member, wherein the light reflecting member is disposed under the pressing portion.

10. The ear handle according to claim 8, wherein a distance between the pressing portion and the optical pressure sensor is not greater than 1 mm.
